(19) United States
(12) Patent Application Publication
(10) Pub. No.: US 2017/0059057 A1
(43) Pub. Date: Mar. 2, 2017

(54) ELECTROMAGNETIC PROPORTIONAL CONTROL VALVE SYSTEM

(71) Applicant: Kenpei YAMAJI, Ryugasaki-shi (JP)

(72) Inventor: Kenpei YAMAJI, Ryugasaki-shi (JP)

(21) Appl. No.: 15/245,238

(22) Filed: Aug. 24, 2016

(30) Foreign Application Priority Data
Aug. 27, 2015 (JP) 2015-167474

(51) Int. Cl. F16K 31/42; F15B 13/044; F15B 13/04; F16K 11/07; F15B 11/08

(52) U.S. Cl. CPC F16K 31/426; F16K 11/07; F15B 11/08; F15B 13/0406; F15B 13/044; F15B 2013/0412; F15B 2211/665

(57) ABSTRACT

In an electromagnetic proportional control valve system, left and right position control apparatuses 20 and 30 are disposed on the both ends of a main spool in a three position proportional control valve 10 and perform stroke control for the main spool. The left and right position control apparatus respectively comprise position feedback springs 25 and 35, pilot control valves 21 and 31, and proportional solenoids 27 and 37. The pilot spool is moved, for operative control, in response to a compression force of a position feedback spring and an electromagnetic force of the proportional solenoid. In addition, the output pressure is applied to both ends of the pilot spool so that control is performed to generate output pressure with a negative characteristic against the electromagnetic force of the proportional solenoids.

### RELATED APPLICATION

This invention claims the benefit of Japanese Patent Application No. 2015-167474 which is hereby incorporated by reference.

### TECHNICAL FIELD

The present invention relates to a system using an electromagnetic proportional control valve which performs spool position control using an electromagnetic force.

### TECHNICAL BACKGROUND

As one of directional control valves, a three position directional control valve, which performs switching control for fluid supply in three directions (a fluid supply position in a forward direction, a supply suspension position, and a fluid supply position in a backward direction), is publicly known. As this type of directional control valves, there is one which merely performs three ON/OFF position switching, however, there is also one which performs proportional control of amount of supplying fluid in response to amount of a spool stroke from the supply suspension position (a neutral position). Regarded to this proportional control concerned, in addition to direct control valve by manual, there are also well-known proportionally controlled valves as using a pilot pressure or operatively controlled electric (operatively controlled electromagnetic force) (for example, refer to Patent Document 1).

FIG. 7 illustrates a system configuration of the three position directional control valve which is operatively controlled electrically. This system comprises, in addition to the three position proportional control valve 100, left and right springs 102a and 102b, and electromagnetic proportional pressure reducing valves 111 and 112 controlling pilot pressure supply to left and right ends of the spool from a pilot pressure source 115, in order to perform spool position control. The three position proportional control valve 100 switches from the neutral position (supply suspension position) 101c, to the left activated position 101a, or the right activated position 101b. In response to a position of the spool, it stops hydraulic supply to an actuator 108 by setting a position of the spool to the neutral position 101c, supplies hydraulic oil from a hydraulic pump 105 to a left oil chamber (bottom side oil chamber) of the actuator 108 and discharges the hydraulic oil of a right oil chamber (rod side oil chamber) to the tank 106 by setting to the left activated position 101a (setting the left activated position 101a to the center, illustrated as the neutral position 101c), and supplies the hydraulic oil from the hydraulic pump 105 to the right oil chamber of the actuator 108 and discharges the hydraulic oil in the left oil chamber to the tank 106 by setting the right activated position 101b.

In order to perform position control of the three position proportional control valve 100, that is, spool position control, a command signal is transmitted to the electromagnetic pressure reducing valve 111 or 112, and pilot pressure depending on the command signal is applied on an end of the spool. For example, in order to move the spool leftward, pilot pressure is applied on the right end of the spool by the right electromagnetic proportional pressure reducing valve 112. This makes the spool pressed to stroke to leftward direction until the force generated with pilot pressure balances with the spring force of the left spring 102a so that the spool is settled on the rightward activated position 101b with the stroke corresponding to the above mentioned command signal.

### RELATED PRIOR ARTS

### Patent Document

[Patent Document 1] Japanese Laid-Open Patent Publication No. 2015-98936(A)

### SUMMARY OF THE INVENTION

In the system configured above, there exists a problem of a large spring size because of the necessity of a relatively large spring force led when taking such factors into account as working range and control accuracy of the electromagnetic proportional pressure reducing valve, area of the end of the spool on which the pilot pressure is applied, a force necessary to restrain an influence due to such external factors as fluid force by flow, frictional force, etc. generated on the spool when it moves, and necessary force for the spool to return surely to the neutral position. Furthermore, although it is preferable that the electromagnetic proportional control valve is integrally installed into the chamber storing the spring, however, there arises a space problem around the end parts of the spool of the three position proportional control valve, and this is likely to expand to the space problem of total valve system.

The present invention is derived in view of such a problem, and aims to provide an electromagnetic proportional control valve system with reduced spring force, enabling to obtain a predetermined control characteristic with a possibility for downsizing.

In order to achieve the object, an electromagnetic proportional control valve system according to an aspect of the present invention is configured to comprise a three position proportional control valve, and left and right position control apparatuses which are provided on both ends of a main spool in the three position proportional control valve for stroke control of the main spool. The left and right position control apparatuses respectively comprises a compressible position feedback spring which confronts with the main spool end, a pilot control valve disposed so as to confront to the side of the position feedback spring opposed to the main spool end across the position feedback spring, and a proportional solenoid providing an electromagnetic expanding force applicable to the opposite side of pilot spool in the pilot control valve against the position feedback spring. The concerned pilot spool is configured to be moved in response to compression force of the position feedback spring and electromagnetic force of the proportional solenoid in order to control the pilot control valve operatively, with its output pressure applied on the both ends of the pilot spool additionally, so that control is performed to generate the output pressure with a negative characteristic against the electromagnetic force of the proportional solenoid.

In the electromagnetic proportional control valve system, it is preferable that when the main spool is moved either leftward or rightward from the neutral position, the position feedback spring in the moving direction side is compressed by the main spool, and on the other hand, in the side oppose to moving direction the main spool is configured to step away from the position feedback spring in the side oppose to moving direction.

In the electromagnetic proportional control valve system, it is preferable that in the position control apparatus oppose to the moving direction, output pressure, by the pilot control valve, generated in response to an electromagnetic force of the proportional solenoid shows a negative characteristic, and the position control apparatus works as an electromagnetic proportional pressure reducing valve.

In the electromagnetic proportional control valve system, it is preferable that in the position control apparatus in the moving direction side, spring force by the position feedback spring which varies in response to compression by stroke of the main spool is applied on the pilot spool to play as a feedback to the electromagnetic force of the proportional solenoid in order to establish closed loop position control.

In the electromagnetic proportional control valve system, it is preferable that adjusting means by adjusting compression force are provided in parallel with the proportional solenoid respectively in the left and right position control apparatuses. Compression force adjusted by the adjusting means is configured to work onto an end of the pilot spool in opposition to the end confronted by the position feedback spring, to be combined together with electromagnetic force generated by the proportional solenoid.

### Advantageous Effects of the Invention

According to the electromagnetic proportional control valve system set forth in the present invention, it is possible to make the position feedback spring small, and by integrating it into the pilot control valve, it is possible to realize the compact structure.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 illustrates an explanatory diagram showing a schematic configuration of an electromagnetic proportional control valve system according to the present invention.

FIG. 2 illustrates an explanatory diagram showing a whole configuration of a system while showing in detail a configuration of a position control apparatus of the electromagnetic proportional control valve system.

FIG. 3 illustrates an explanatory diagram showing in detail a right position control apparatus in the electromagnetic control valve system shown in FIG. 2.

FIG. 4 illustrates a graph showing a control characteristic by the right position control apparatus.

FIG. 5 illustrates a configuration explanatory diagram showing in detail a left position control system of the electromagnetic proportional control valve system shown in FIG. 2.

FIGS. 6A and 6B illustrate a graph showing a relationship between a spool stroke and control pressure in the electromagnetic proportional control valve system according to the present invention and a conventional proportional control valve system.

FIG. 7 illustrates an explanatory diagram showing the conventional proportional control valve system.

### DESCRIPTION OF THE EMBODIMENTS

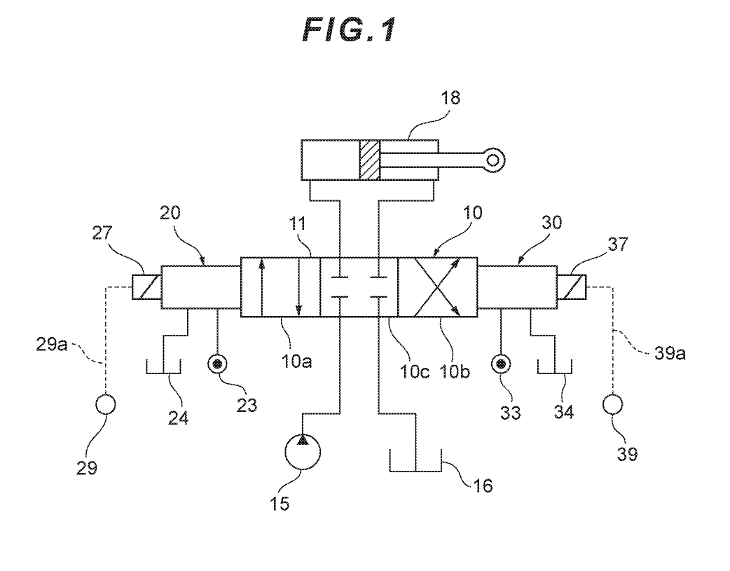

The preferable embodiments are now described with reference to drawings. The electromagnetic proportional control valve system according to the present embodiment controls to supply, as shown in FIG. 1, hydraulic oil from a hydraulic pump 15 to an actuator 18 by means of a three position proportional control valve 10, and comprises a left position control apparatus 20 and a right position control apparatus 30 controlling activation of the three position proportional control valve. These left and right position control apparatuses 20 and 30 control stroke of a main spool 11 in the three position proportional control valve 10, and sets the three position proportional control valve 10 to any one of a left activated position 10a, a neutral position 10c and a right activated position 10b.

Specifically, hydraulic supply to the actuator 18 from the hydraulic pump 15 is stopped by setting to the neutral position 10c, hydraulic oil from the hydraulic pump 15 is supplied to a left oil chamber (bottom side oil chamber) of the actuator 18 and hydraulic oil in a right oil chamber (rod side oil chamber) is discharged to the tank 16 by setting to the left activated position 10a(placing the left activated position 10a to a location illustrated as the neutral position 10c), and the hydraulic oil from the hydraulic pump 15 is supplied to the right oil chamber of the actuator 18 and the hydraulic oil in the left oil chamber is discharged to the tank 16 by setting the right activated position 10b. Note that when setting to the left activated position 10a or the right activated position 10b, oil flow supplied to the actuator 18 from the hydraulic pump 15 is controlled (proportionally controlled) in response to amount of stroke of the main spool 11.

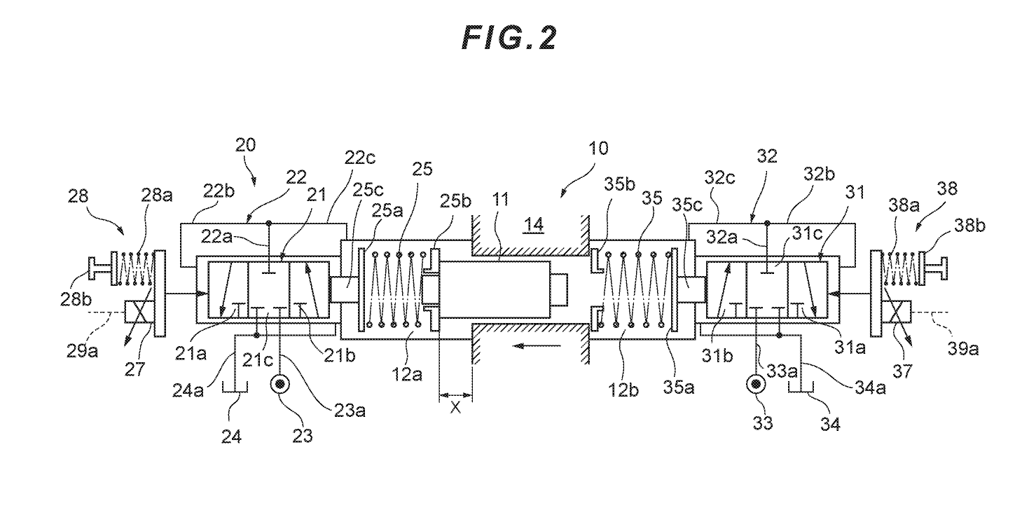

As shown the configuration in FIG. 2 in detail, the left and right position control apparatuses 20 and 30 are symmetrically configured across the main spool 11. Note that in FIG. 2 the main spool 11 is solely simplified as is supported in an axially movable manner by the housing 14 of the three position proportional control valve 10, but other configurations are omitted. The left and right position control apparatuses 20 and 30 respectively comprise left and right pilot control valves 21 and 31, left and right position feedback springs 25 and 35, and left and right proportional solenoids 27 and 37. Left and right chambers 12a and 12b are formed beside the housing 14 of the three position proportional control valve 10 in a manner of covering left and right ends of the main spool 11 respectively. The left and right position feedback springs 25 and 35 are respectively installed inside the chambers 12a and 12b. These position feedback springs 25 and 35 respectively contact, as illustrated in the drawing, with the left and right ends of the main spool 11 via inner support plates 25b and 35b.

Furthermore, left and right pilot control valve 21 and 31 are respectively provided outside the chamber 12a or 12b so that they respectively confront the position feedback spring 25 or 35. An inner end of a pilot spool of these left and right pilot control valve 21 or 31 confronts and contacts the position feedback spring 25 or 35 via pushpin 25c or 35c and outside support plate 25a or 35a respectively, and an outer end of the pilot spool confronts and contacts the proportional solenoid 27 or 37 respectively. Accordingly, the pilot spool of the pilot control valve 21 or 31 receives compression force of the position feedback spring 25 or 35 from inside respectively, and receive expanding force of the proportional solenoid 27 or 37 from outside respectively. The proportional solenoid 27 and 37 are respectively coupled to controller 29 or 39 via control line 29a or 39a, and are activated in response to control signal from the controller 29 or 39. Note that the controller 29 is integrated with the controller 39.

Pilot pressure line 23a or 33a from pilot supply source 23 or 33, tank line 24a or 34a reaching tank 24 or 34, and outlet line 22 or 32 are coupled to the left or right pilot control valve 21 or 31 respectively. The outlet line 22 or 32 has first outlet line 22a or 32a coupled to outlet port of the left or right pilot control valve 21 or 31, and second outlet line 22b or 32b and third outlet line 22c or 32c branched leftward or rightward from the first outlet line 22a or 32a respectively. The second outlet line 22b and 32b are respectively coupled to the outer end oil chamber of the pilot control valve 21 or 31, and the third outlet line 22c and 32c are respectively coupled to the left or right chamber 12a or 12b. Accordingly, internal pressure in the left or right chamber 12a or 12b is applied on an inner end of the pilot spool via the pushpin 25c or 35c respectively, and same pressure as this internal pressure is applied on an outer end of the pilot spool. As illustrated in the drawing that the diameter of the pushpin is smaller than that of the pilot spool, the pressure-receiving area of the inner end is smaller than that of the outer end. Note that the pilot supply source 23 is structurally identical with the pilot supply source 33, thus they respectively supply the same pilot pressure. It is appreciated that the tanks 24 is integrated with the tank 34.

The pilot control valve 21 and 31 are configured to be set to the neutral position 21c or 31c, the outer activated position 21a or 31a, and the inner activated position 21b or 31b respectively in response to movement of the pilot spool. When set to the neutral position 21c or 31c, a connection between the pilot pressure line 23a or 33a and the tank line 24a or 34a, and the outlet line 22 or 32 is severed. When set to the inner activated position 21b or 31b, the pilot pressure line 23a or 33a is coupled with the outlet line 22 or 32, thus pilot pressure is supplied to the outlet line 22 or 32 from the pilot pressure supply source 23 or 33. On the other hand, when set to the outer activated position 21a or 31a, the tank line 24a or 34a is coupled with the outlet line 22 or 32, thus oil is discharged to the tank 24 or 34 from the outlet line 22 or 32.

Way of controlling hydraulic oil supply to the actuator 18 from the hydraulic pump 15 by using the electromagnetic proportional control valve system as configured above is described as follows. FIG. 2 illustrates a state in which the main spool 11 strokes leftward by distance X. Firstly, actuation of the right position control apparatuses 30 in this state is described. In the right position control apparatuses 30, the right inner support plate 35b contacts the housing 14, and the main spool 11 is driven away from the right inner support plate 35b. Accordingly, a pushing force does not act onto the main spool 11 from the right position feedback spring 35, in other words, compression force by the main spool 11 is not generated on the right position feedback spring 35.

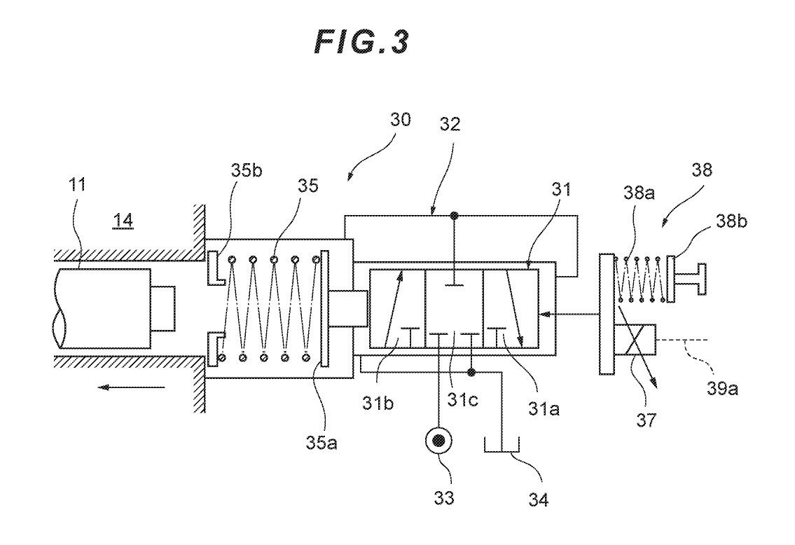

FIG. 3 illustrates in detail the right position control apparatuses 30 in this state. A right adjustment mechanism 38 is provided in parallel with the right proportional solenoid 37, and a right adjustment spring 38a in which pushing force is adjustable by a right adjustment screw 38b is provided. In this state, F(R)sol denotes the electromagnetic expanding force inward which acts toward the right pilot spool of the right pilot control valve 31 from the right proportional solenoid 37. F(R)fb denotes pushing force outward which acts onto the right pilot spool from the right position feedback spring 35. F(R)ad denotes force inward which acts onto the right pilot spool from the right adjustment spring 38a. Pb is hydraulic pressure inside the right chamber 12b. A(R)z denotes pressure-receiving area which receives hydraulic pressure inside the right chamber 12b toward the right pilot spool, and A(R)y denotes pressure-receiving area which receives hydraulic pressure led from the right-outlet line 32 onto the right (outer) end of the right pilot spool, and the following conditional expression (1) showing a relationship of forces which act on the right pilot spool is satisfied. Note that both pressure-receiving area are defined so that A(R)y>A(R)z is satisfied.

(Math 1)

Pb*(A(R)y−A(R)z)+F(R)sol+F(R)ad=F(R)fb (1)

Based on the conditional expression (1), hydraulic pressure Pb in the right chamber 12b, that is, right control pressure Pb which is pressure of the outlet line 32 adjusted by the right pilot control valve 31, is defined by the conditional expression (2).

(Math 2)

Pb=[−F(R)sol+(F(R)fb−F(R)ad)]/(A(R)y−A(R)z) (2)

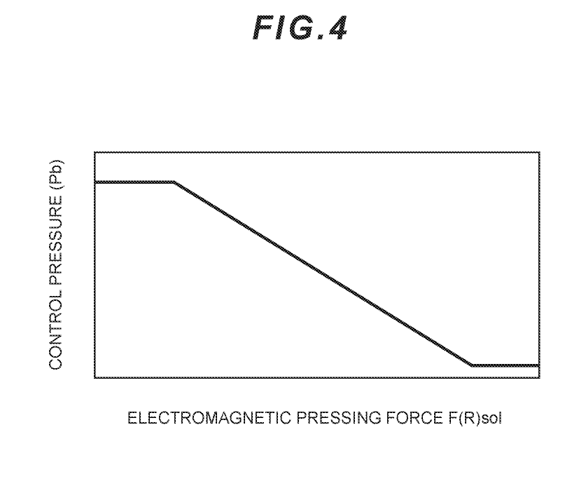

In the conditional expression (2), compression force F(R)fb of the right position feedback spring 35 and compression force F(R)ad by the right adjustment spring 38a are constant, and pressure-receiving area A(R)y and A(R)z are constant (however, A(R)y>A(R)z), the right control pressure Pb can be controlled by controlling the electromagnetic force F(R)sol of the right proportional solenoid 37. In the conditional expression (2), the right control pressure Pb has an inverse proportion relationship to the electromagnetic force F(R)sol, because the coefficient of electromagnetic force F(R)sol becomes a negative value. This relationship is shown in FIG. 4, and FIG. 4 illustrates the right control pressure Pb on the vertical axis and the electromagnetic force F(R)sol on the horizontal axis. As understandable based on the above, the right position control apparatus 30 in this state activates as an electromagnetic proportional pressure reducing valve.

Note that when the right control pressure Pb becomes high from a state shown in FIG. 3, the right pilot spool is forced leftward due to a relationship of the pressure-receiving area A(R)y>A(R)z and the right pilot control valve 31 is set to the outer activated position 31a. With this arrangement, the hydraulic oil in the right chamber 12b is discharged to the tank 34, therefore the right control pressure Pb falls, and the right pilot spool is returned rightward. On the other hand, when the right control pressure Pb becomes low, the right pilot spool moves rightward, the right pilot control valve 31 is set to the inner activated position 31b, pilot pressure is supplied to the outlet line 32 from the pilot supply source 33, and the right pilot spool is returned leftward. With the activation above, the right pilot spool is held in a state shown in FIG. 3, that is, at a position in which a relationship of the conditional expression (2) determined with the electromagnetic force Fsol is satisfied, and the right control pressure Pb is maintained at pressure defined by the conditional expression (2) in response to the electromagnetic force Fsol.

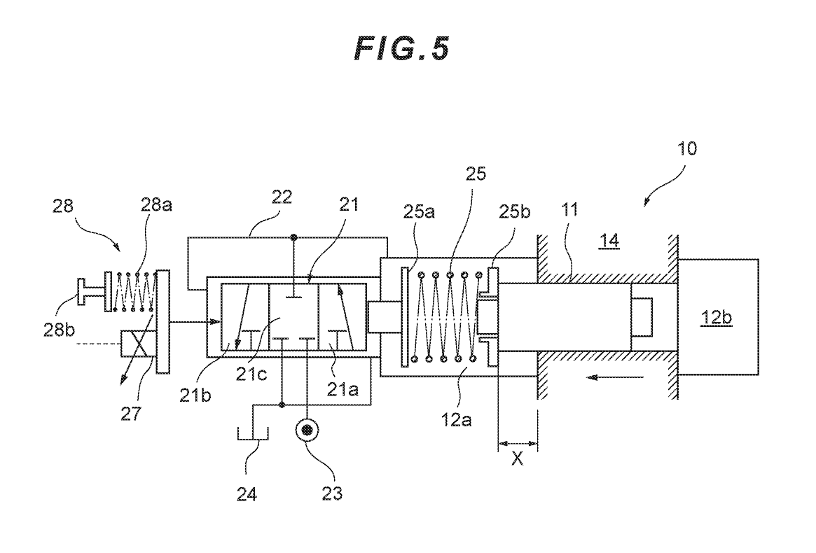

Next, the left position control apparatus 20 in a state shown in FIG. 2 is illustrated in detail in FIG. 5. A left adjustment mechanism 28 having a left adjustment screw 28a with which pushing force is adjustable by a left adjustable screw 28b is provided in parallel with the left proportional solenoid 27, also in the left position control apparatus 20 as well as the right position control apparatus 30. In this state, the main spool 11 projects inside the left chamber 12a, and compresses the left position feedback spring 25 via the left inner support plate 25b. In this state, F(L)sol denotes electromagnetic force inward which acts onto the left pilot spool of the left pilot control valve 21 from the left proportional solenoid 27. F(L)fb denotes pushing force outward which acts onto the left pilot spool from the left position feedback spring 25 which is in a state of compression as above. F(L)ad denotes compression force inward which acts onto the left pilot spool from the left adjustment spring 28a. Pa denotes hydraulic pressure in the left chambers 12a. Asp denotes pressure-receiving area (corresponding to area which receives pressure from the chambers 12a and 12b, and the left has the same area as that of the right) of the main spool. A(L)z denotes pressure-receiving area which receives hydraulic pressure from the left chamber 12a in the left pilot spool, and A(L)y denotes pressure-receiving area which receives hydraulic pressure from the left outlet line 22 onto the left (outer) end of the left pilot spool. Under the premise above, a relationship between the forces which act on the main spool 11 and the left pilot spool will be now considered. Note that A(L)y>A(L)z is satisfied, and k denotes the spring constant of the left position feedback spring 25, and F(L)fb0 denotes spring force when the left position feedback spring 25 is in the neutral position (when X=0).

Firstly, a relationship of forces which act on the main spool 11 can be defined by the following conditional expression (3).

(Math 3)

Asp*Pa+F(L)fb=Asp*Pb (3)

Meanwhile, a relationship of forces which act on the main spool 11 when the left feedback spring 25 is in the neutral position (When X=0) can be defined by the following conditional expression (4). However, this denotes a relationship of forces at the position just before the main spool 11 contacts the right inner support plate 35b, that is, a relationship of forces at a starting position at which the main spool 11 starts to move leftward. Moreover, Pa0 denotes hydraulic pressure in the chamber 12a in this state.

(Math 4)

Asp*Pa0+F(L)fb0=Asp*Pb (4)

A relationship of forces which act on the left pilot spool of the left pilot control valve 21 is defined by the following conditional expression (5).

(Math 5)

F(L)sol+F(L)ad+Pa*A(L)y=F(L)fb+Pa*A(L)z (5)

On the other hand, a relationship of forces which act on the left pilot spool when the left position feedback spring 25 is in the neutral position (when X=0) is defined by the following conditional expression (6).

(Math 6)

Pa0*(A(L)y−A(L)z)+F(L)sol0+F(L)ad=F(L)fb0 (6)

Wrapping up the conditional expressions (3) to (6), the following conditional expression (7) is obtained.

(Math 7)

F(L)sol=(F(L)fb−F(L)fb0)*[1+(A(L)y−A(L)z)/Asp]+F(L)sol0 (7)

The following conditional expression (8) is satisfied based on a characteristic of the left position feedback spring 25.

(Math 8)

F(L)fb=K*X+F(L)fb0 (8)

The following conditional expression (9) is obtained based on the conditional expressions (7) and (8).

(Math 9)

F(L)sol=K*[1+(A(L)y−A(L)z)/Asp]*X+F(L)sol0 (9)

In the conditional expression (9), K*[1+(A(L)y−A(L)z)/Asp] and F(L)sol0 are also constant, thus it is understandable that expanding force of the left proportional solenoid 27 has a proportional relationship with a stroke X of the main spool 11. At this point, when increasing the electromagnetic force F(L)sol of the left proportional solenoid 27, the left pilot control valve 21 is set to the external activated position 21b by moving the pilot spool rightward, and the outlet line 22 is coupled to the tank. As a result, since the left control hydraulic pressure Pa in the left chamber 12a falls, the main spool 11 moves leftward, therefore the left position feedback spring 25 is compressed, and the pilot spool is returned back. This mechanism stops with the pilot spool balanced in a state in which a relationship of the above conditional expression (9) is satisfied. As mentioned above, the position of the main spool 11 is closed-loop controlled via the left position feedback spring 25 in response to the command (the electromagnetic force F(L)sol of the left proportional solenoid 27).

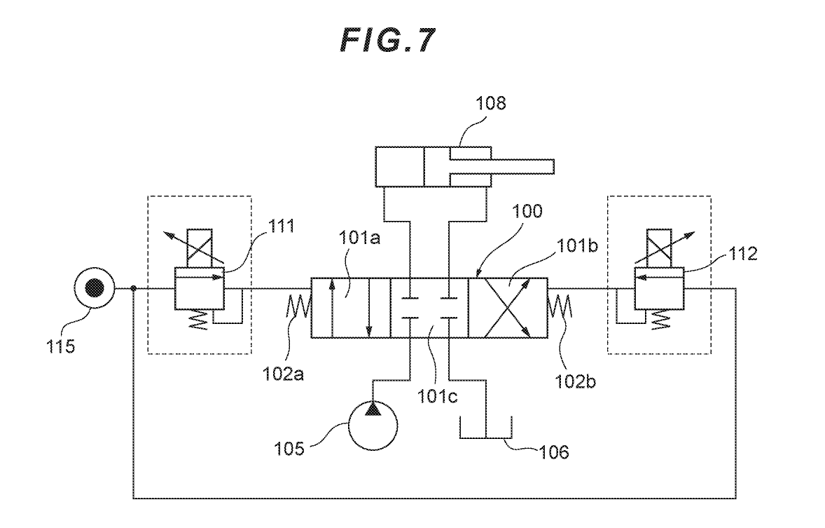

At this point, a case of a conventional three position proportional control valve 100 shown in FIG. 7 will be now compared with a case of the three position proportional control valve 10 relating to the electromagnetic proportional control valve system according to the embodiment above. In case of the conventional three position proportional control valve 100 shown in FIG. 7, for example, assuming that a diameter of the spool is 28 mm, a maximum stroke to either end from the neutral position is 10 mm, and the pilot pressure control range of the electromagnetic proportional pressure reducing valves 111 and 112 is up to 26 bar from 2.5 bar, the springs 102a and 102b should have a specification of 15.4 kgf as initial setting force and 160.0 kgf as maximum force at maximum stroke 10 mm.

In the electromagnetic proportional control valve system according to the present invention above, in case that the diameter of the main spool is 28 mm and the maximum stroke in any one of rightward and leftward directions is 10 mm, an electromagnetic force of the proportional solenoid is set to 1.5 kgf at a maximum, a control pressure is 20 bar when the electromagnetic force is 0 kgf, a difference between pressure-receiving area inside and outside of the pilot spool (A(L)y−A(L)z above-mentioned) is set to 4.50 mm², then it is possible to obtain the position feedback springs 25 and 35 having reduced values such as 0.9 kgf for initial setting force and 2.4 kgf for maximum force when stroke is maximum 10 mm. As mentioned above, this enables to reduce the maximum load to the spring down to 2.4 kgf from 160 kgf, hence, approximately 1/67.

According to the electromagnetic proportional control valve system set forth in the embodiment of the present application as described above, it is possible to downsize the position feedback springs 25 and 35, furthermore to have a compactly configured system by integrating the spring into the pilot control valves 21 and 31.

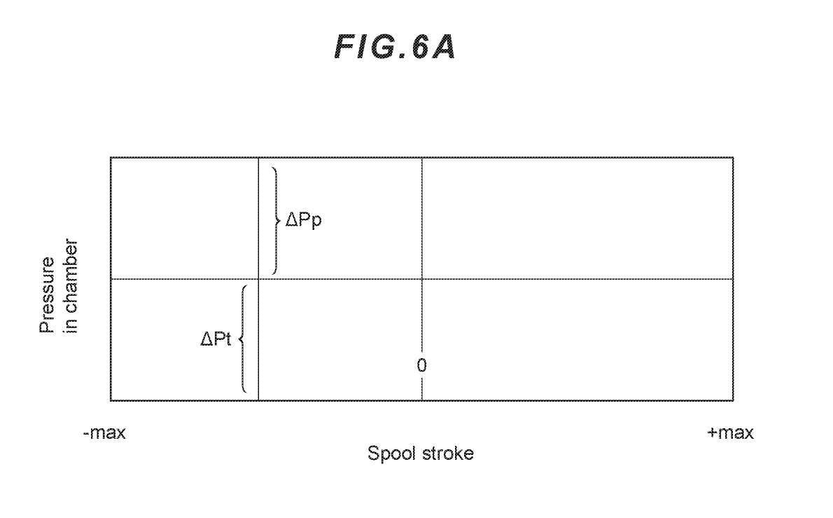

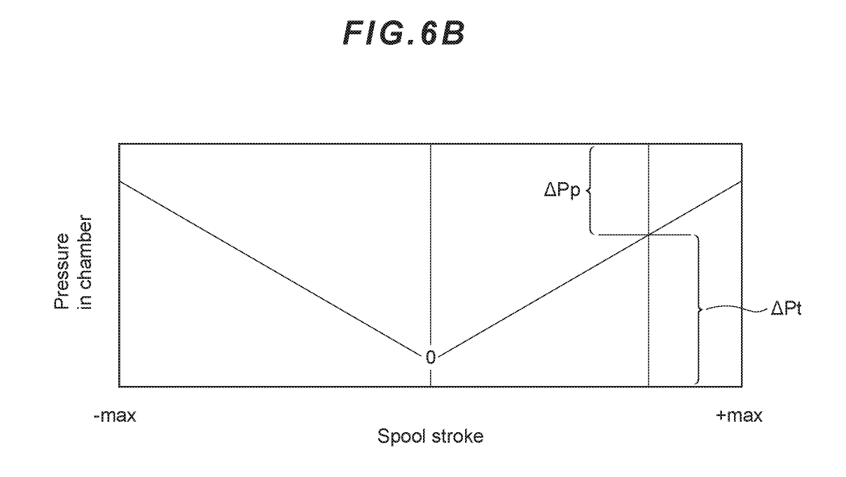

Moreover, the conventional electromagnetic proportional valve control system shown in FIG. 7 has a configuration in which a large confronting spring is compressed, thus, as illustrated in FIG. 6B, in addition to a spring force necessary to hold the spool at the neutral position, the spring force has to be increased in response to an increase of a stroke, thus large spring compression energy is accumulated. As the large energy accumulated above must be released when returning the spool to the neutral position, therefore, spool speed controllability has to get deteriorative. On the other hand, in the electromagnetic proportional control valve system according to the embodiment of the present invention, the control pressure Pa and Pb in the chambers 12a and 12b respectively storing the position feedback springs 25 and 35, that is, output pressure of the pilot control valves 21 and 31 are approximately constant each other, therefore, as illustrated in FIG. 6A, differential pressure ΔPp generated by meter-in or meter-out orifice of pilot spool in the pilot control valve 21 or 31 is generally constant, thus controllability can be stable and appropriately maintained throughout whole stroke range of the main spool 11.

Furthermore, as shown in FIG. 5, on a side at which the position feedback spring is compressed by the main spool 11, closed-loop control is performed, thus it is possible to raise rigidity of position holding by using controlled pressure, additionally even though the position feedback spring is small, there may be less influential based on disturbances such as fluid force by flow and fluid sticking force caused by pressure unbalance, etc., therefore it is possible to realize highly-precise position control.

Even if a command signal is severed due to an unexpected incident, the same operations as those of a conventional control system are guaranteed. For example, if control signals of both of the left and right proportional solenoids 27 and 37 are not available, the main spool 11 will return to the neutral position. When a control signal of the proportional solenoid in the position control system on a side shown in FIG. 3 becomes not available, a current position of the main spool 11 is maintained. Furthermore, it is possible to return the main spool 11 to the neutral position by using the position control system on an opposite side from this state. When a control signal of the proportional solenoid in the position control apparatus on a side shown in FIG. 5 becomes not available, the main spool is forced to the opposite direction due to increased internal pressure of the chamber, however with this arrangement the position control apparatus on the opposite side will begin to perform position control, and maintain to perform the position control until pressure of both ends of the main spools get equal to each other (pressure of the left and right chambers are equal to each other), consequently, the main spool returns to near the neutral position to keep its position.

The invention being thus described; it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electromagnetic proportional control valve system configured to comprise a three position proportional control valve and left and right position control apparatuses which, provided on both ends of a main spool in the three position proportional control valve to perform stroke control for the main spool, respectively comprises a compressible position feedback spring which confronts with a main spool end, a pilot control valve disposed so as to confront to the position feedback spring in opposition to the main spool end across the position feedback spring, and a proportional solenoid providing electromagnetic expanding force applicable to an opposite end of pilot spool in the pilot control valve against the position feedback spring,
wherein the pilot spool is configured to be moved in response to compression force of the position feedback spring and electromagnetic force of the proportional solenoid in order to control the pilot control valve operatively, with its output pressure applied on the both ends of the pilot spool additionally, so that control is performed to generate the output pressure—with a negative characteristic against the electromagnetic force of the proportional solenoid.

2. An electromagnetic proportional control valve system according to claim 1, wherein when the main spool is moved either leftward or rightward from a neutral position, the position feedback spring in the moving direction side is compressed by the main spool, and in the side oppose to moving direction the main spool is configured to step away from the position feedback spring in the side oppose to moving direction.

3. An electromagnetic proportional control valve system according to claim 2, wherein in the position control apparatus oppose to the moving direction, output pressure, by the pilot control valve, generated in response to an electromagnetic force of the proportional solenoid shows a negative characteristic, and the position control apparatus works as an electromagnetic proportional pressure reducing valve.

4. An electromagnetic proportional control valve system according to claim 2, wherein in the position control apparatus in the moving direction side, a spring force by the position feedback spring which varies in response to compression by stroke of the main spool is applied on the pilot spool to play a feedback to the electromagnetic force of the proportional solenoid is in order to establish closed loop position control.

5. An electromagnetic proportional control valve system according to claim 1, wherein adjusting means by adjusting compression force are provided in parallel with the proportional solenoid respectively in the left and right position control apparatuses so as for force adjusted by the adjusting means to be configured to work onto an end of the pilot spool in opposition to the end confronted by the position feedback spring, to be combined together with electromagnetic force generated by the proportional solenoid.
